(19) United States
(12) Patent Application Publication
(10) Pub. No.: US 2024/0218823 A1
(43) Pub. Date: Jul. 4, 2024

(54) COOLING MODULE FOR AN ELECTRIC OR HYBRID MOTOR VEHICLE

(71) Applicant: VALEO SYSTEMES THERMIQUES, La Verriere (FR)

(72) Inventors: Amrid MAMMERI, La Verriere (FR); Kamel AZZOUZ, La Verriere (FR)

(73) Assignee: VALEO SYSTEMES THERMIQUES, La Verriere (FR)

(21) Appl. No.: 18/552,068

(22) PCT Filed: Mar. 17, 2022
(86) PCT No.: PCT/EP2022/056992

§ 371 Date: Sep. 22, 2023

(30) Foreign Application Priority Data
Mar. 25, 2021 (FR) 2102985

(51) Int. Cl. F01P 5/06; B60K 11/08; F04D 17/02

(52) U.S. Cl. CPC F01P 5/06; B60K 11/08; F04D 17/02; F01P 2050/24

(57) ABSTRACT

A cooling module for an electric or hybrid motor vehicle, the cooling module being intended to have an air flow pass there through and including: a shroud forming an internal channel through which the air flow passes and including at least one heat exchanger; a first manifold housing, which is located downstream of the shroud and has a guide wall and a tangential turbomachine having a volute comprising an outlet for the air flow. The cooling module includes a deflector grid located at the outlet of the volute, the deflector grid projecting from an outer edge of the outlet and extending on an inclined plane oriented towards the guide wall, the deflector grid having a series of blades, which are stacked, extend along a transverse axis perpendicular to the longitudinal direction of the cooling module and are rotatable about their transverse axis between a closed position and an open position.

### TECHNICAL FIELD

The present invention relates to a cooling module for an electric or hybrid motor vehicle, having a tangential-flow turbomachine.

### BACKGROUND OF THE INVENTION

A cooling module (or heat-exchange module) of a motor vehicle conventionally comprises at least one heat exchanger and a ventilation device which is designed to generate an airflow in contact with the at least one heat exchanger. The ventilation device thus makes it possible, for example, to generate an airflow in contact with the heat exchanger, when the vehicle is stationary or running at low speed.

Conventionally, the heat exchanger is then placed in a compartment facing at least two cooling openings, formed in the front face of the body of the motor vehicle. A first cooling opening is situated above the fender while a second opening is situated below the fender. Such a configuration is preferred since the thermal engine also has to be supplied with air, the air intake of the engine being conventionally situated in the passage of the airflow passing through the upper cooling opening.

Depending on the different vehicles, this compartment can be reduced in size to a greater or lesser extent and obstructed by obstacles potentially hindering the discharge of the airflow passing through it. This is particularly the case when the airflow is generated by the ventilation device. It is therefore necessary to increase the size and/or power of this ventilation device so that the airflow is sufficient for heat exchange to take place correctly at the heat exchanger(s). This is not the most optimal solution, as it consumes a lot of energy and can reduce the range of the electric or hybrid vehicle. Furthermore, such a solution leads to an increase in the weight of the cooling module.

### BRIEF SUMMARY OF THE INVENTION

The objective of the present invention is thus to eliminate the disadvantages of the prior art at least partly, and to propose an improved cooling module which permits optimal performance levels whilst limiting its energy consumption as well as its overall size.

The present invention thus concerns a cooling module for an electric or hybrid motor vehicle, said cooling module being designed to have an airflow passing through it, and comprising:
a fairing forming an internal channel through which the airflow passes between an upstream end and a downstream end opposite each other, said fairing comprising at least one heat exchanger,
a first collector housing arranged downstream of the fairing in a longitudinal direction of the cooling module from the front to the rear of said cooling module, said first collector housing comprising a guide wall facing the heat exchanger downstream of the fairing, said guide wall being intended to guide the airflow towards a tangential turbomachine configured so as to generate said airflow, said tangential turbomachine comprising a volute including an airflow outlet,
the cooling module comprising at least one deflector grille arranged at the outlet of the volute, said deflector grille extending an outer edge of the outlet and lying on an inclined plane oriented towards the guide wall, said deflector grille comprising a series of superimposed blades each extending along a transverse axis perpendicular to the longitudinal direction of the cooling module, said blades being rotatable about their transverse axis between a closed position and an open position.

According to one aspect of the invention, in the closed position, the blades are in contact with each other to form an airflow stop surface.

According to another aspect of the invention, the blade furthest away from the outer edge is, in the closed position, both in contact with the adjacent blade by a first of its edges and in contact with the separating wall by a second of its edges, opposite the first.

According to another aspect of the invention, the deflector grille comprises at least two juxtaposed compartments, each compartment comprising a series of superimposed blades, the compartments being separated by a separating wall connecting the superimposed blades of each compartment to one another.

According to another aspect of the invention, the blades of each compartment are independently rotatable from one compartment to another.

According to another aspect of the invention, the separator walls are movable about an axis of rotation perpendicular to the transverse axis of the blades.

According to another aspect of the invention, the entire width of the cooling module outlet is covered by at least one deflector grille.

According to another aspect of the invention, the blades of the at least one deflector grille have a curved cross-section with a first concave wall facing the outlet and a second convex wall facing away from the outlet.

According to another aspect of the invention, the blades comprise a leading edge through which the airflow is intended to impinge against said blade, a trailing edge through which the airflow is intended to be ejected by said blade, the thickness of the blade cross-section at said leading and trailing edges being less than the central thickness of the blade cross-section.

According to another aspect of the invention, in the open position, the angle between the tangent to the leading edge of the blades of the at least one deflector grille and the velocity vector of the airflow is equal to the angle between the tangent to the trailing edge of the turbine blades and the velocity vector of the airflow leaving said turbine.

### BRIEF DESCRIPTION OF THE DRAWINGS

Further advantages and features of the invention will become more clearly apparent from reading the following description, provided by way of illustrative and non-limiting example, and the appended drawings, in which:

FIG. 1 schematically shows the front part of a motor vehicle with an electric or hybrid motor, seen from the side,

FIG. 2 shows a partially cross-sectional perspective view of a cooling module,

FIG. 3 shows a cross-sectional view of a first collector housing of the cooling module in FIG. 2,

FIG. 4 shows a cross-sectional perspective view of a deflector grille,

FIG. 5 shows a cross-sectional view of a closed deflector grille,

FIG. 6 shows a perspective view of the rear face of a first collector housing according to the first embodiment,

FIG. 7 shows a perspective view of the rear face of a first collector housing according to a second embodiment,

FIG. 8 shows a cross-sectional view of the blades of a deflector grille, and

FIG. 9 shows a cross-sectional view of the turbine blades.

### DETAILED DESCRIPTION OF THE INVENTION

In the various figures, identical elements bear the same reference numbers.

The following embodiments are examples. Although the description refers to one or more embodiments, this does not necessarily mean that each reference relates to the same embodiment, or that the features apply only to one embodiment. Simple characteristics of different embodiments can also be combined and/or interchanged to provide other embodiments.

In the present description, some elements or parameters can be indexed, such as, for example, first element or second element, as well as first parameter and second parameter or also first criterion and second criterion, etc. In this case, the indexing is simply to differentiate between, and denote, elements or parameters or criteria that are similar, but not identical. This indexing does not imply any priority of one element, parameter or criterion over another and such denominations can easily be interchanged without departing from the scope of the present description. Nor does this indexing imply any chronological order, for example, in assessing any given criterion.

In the present description, “upstream” is intended to mean that an element is placed before another with respect to the direction of circulation of the airflow. By contrast, “downstream” is intended to mean that an element is placed after another with respect to the direction of circulation of the airflow.

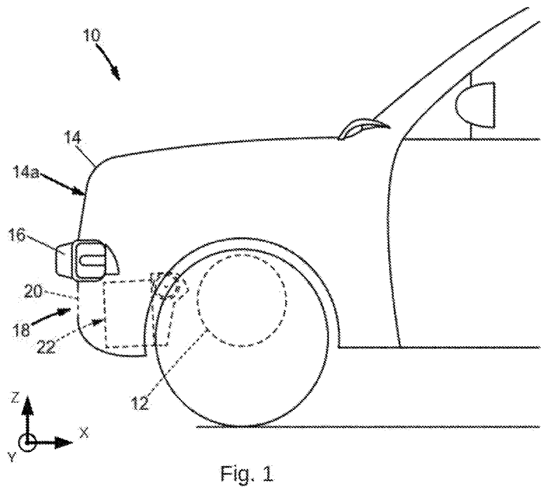

In FIGS. 1 to 6, a trihedron XYZ is shown in order to define the orientation of the various elements in relation to one another. A first direction, denoted X, corresponds to a longitudinal direction of the vehicle. It also corresponds to a direction opposite to the direction of forward movement of the vehicle. A second direction, denoted Y, is a lateral or transverse direction. Finally, a third direction, denoted Z, is vertical. The directions X, Y, Z are orthogonal in pairs.

In FIG. 1, the cooling module according to the present invention is illustrated in a functional position, that is to say when it is disposed within a motor vehicle.

FIG. 1 illustrates schematically the front part of an electric or hybrid motor vehicle 10 which can comprise an electric motor 12. In particular, the vehicle 10 comprises a body 14 and a bumper 16 which are supported by a chassis (not depicted) of the motor vehicle 10. The body 14 defines a cooling opening 18, i.e. an opening through the body 14. In this case, there is only the one cooling opening 18. This cooling opening 18 is preferably in the lower part of the front face 14a of the body 14. In the example illustrated, the cooling opening 18 is situated below the bumper 16. A grille 20 can be positioned in the cooling opening 18 to prevent projectiles from being able to pass through the cooling opening 18. A cooling module 22 is positioned facing the cooling opening 18. The grille 20 in particular makes it possible to protect this cooling module 22.

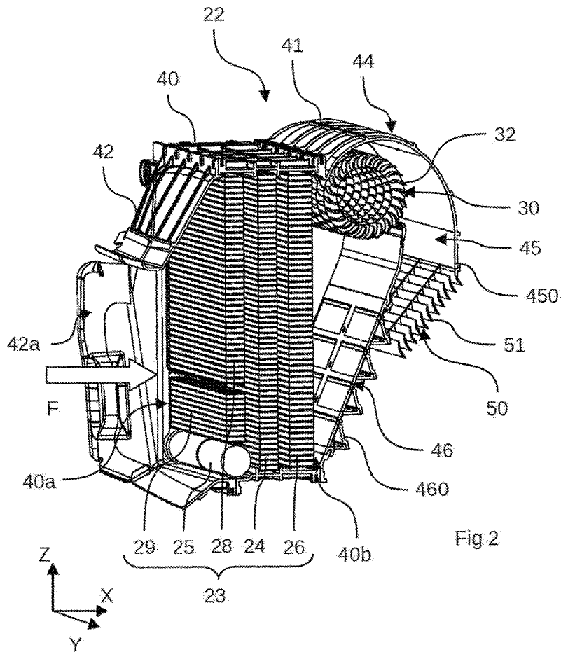

As shown in FIG. 2, the cooling module 22 is designed to have an airflow F passing through it parallel to the direction X, and going from the front to the rear of the vehicle 10. This direction X more particularly corresponds to a longitudinal direction X and extending from the front toward the rear of the cooling module 22. In the present application, an element which is positioned further forward or rearward than another element is referred to respectively as being “upstream” or “downstream”, in the longitudinal direction X of the cooling module 22. The front corresponds to the front of the motor vehicle 10 in the assembled state, or to the face of the cooling module 22 through which the airflow F is intended to enter the cooling module 22. The rear, for its part, corresponds to the rear of the motor vehicle 10, or to that face of the cooling module 22 through which the airflow F is intended to leave the cooling module 22.

The cooling module 22 essentially has a housing or fairing 40 forming an internal channel between an upstream end 40a and a downstream end 40b, which are opposite to one another. At least one heat exchanger 24, 26, 28, 29 is positioned in the interior of said fairing 40. This internal channel is preferably oriented parallel to the longitudinal direction X such that the upstream end 40a is oriented toward the front of the vehicle 10, facing the cooling opening 18, and such that the downstream end 40b is oriented toward the rear of the vehicle 10. In FIG. 2, the cooling module 22 comprises four heat exchangers 24, 26, 28 and 29 grouped together within a set of heat exchangers 23. However, it could comprise more or fewer depending on the desired configuration.

A first heat exchanger 24 can for example be configured to release heat energy from the airflow F. This first heat exchanger 24 can more particularly be a condenser connected to a cooling circuit (not represented), for example in order to cool the batteries of the vehicle 10. This cooling circuit can for example be an air-conditioning circuit able to cool the batteries and an internal airflow destined for the motor vehicle interior.

A second heat exchanger 26 can also be configured to release heat energy into the airflow F. This second heat exchanger 26 can more particularly be a radiator which is connected to a heat control circuit (not represented) for electrical elements, such as the electric motor 12.

Since the first heat exchanger 24 is generally a condenser of an air-conditioning circuit, the circuit needs the airflow F to be as “cool” as possible in air-conditioning mode. For this purpose, the second heat exchanger 26 is preferably positioned downstream from the first heat exchanger 24 in the longitudinal direction X of the cooling module 22. It is nevertheless entirely conceivable for the second heat exchanger 26 to be positioned upstream from the first heat exchanger 24.

The third heat exchanger 28 can for its part also be configured to release heat energy into the airflow. This third heat exchanger 28 can more particularly be a radiator connected to a thermal management circuit (not shown), which can be separate from the one connected to the second heat exchanger 26, for electrical elements such as the power electronics. It is also entirely conceivable for the second 26 and the third 28 heat exchangers to be connected to a single heat control circuit, for example connected in parallel with one another.

The fourth heat exchanger 29 is arranged here in the same plane as the third heat exchanger 28, more precisely below the latter. In particular, this fourth heat exchanger 29 can be connected to the same cooling circuit as the first heat exchanger 24 and can have a sub-cooling function.

In the example shown in FIG. 2, the set of heat exchangers 23 also includes a desiccant bottle 25 arranged in the same plane as the third 28 and fourth 29 heat exchangers. In particular, this desiccant bottle 25 can also be connected to the same cooling circuit as the first heat exchanger 24.

Again according to the example illustrated in FIG. 2, the second heat exchanger 26 is positioned downstream from the first heat exchanger 24, whereas the third heat exchanger 28 is positioned upstream from the first heat exchanger 24. Other configurations can nevertheless be envisaged, such as, for example, the second 26 and third 28 heat exchangers both being positioned downstream or upstream from the first heat exchanger 24.

In the embodiment illustrated, each of the heat exchangers 24, 26, 28, 29 has a generally parallelepiped form which is determined by a length, a thickness and a height. The length extends in the direction Y, the thickness extends in the direction X, and the height extends in the direction Z. The heat exchangers 24, 26, 28, 29 thus extend on a general plane parallel to the vertical direction Z and the lateral direction Y. This general plane is thus perpendicular to the longitudinal direction X of the cooling module 22.

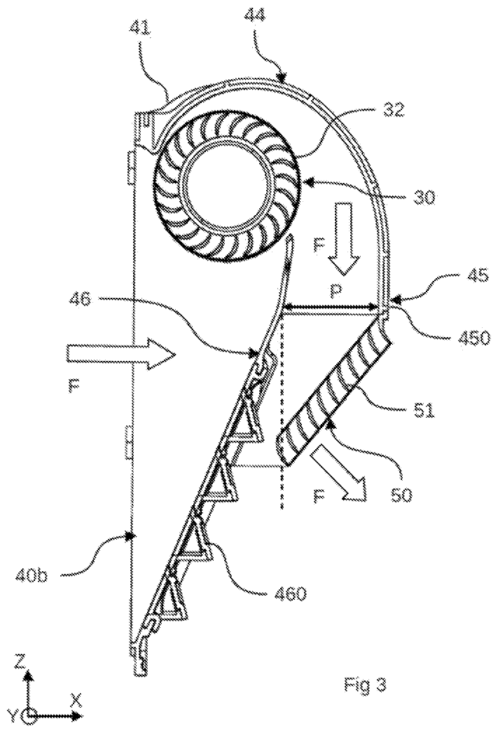

The cooling module 22 also comprises a first collector housing 41 positioned downstream from the set of heat exchangers 23 in the direction of circulation of the airflow. This first collector box 41 can also be seen in greater detail in FIG. 3. The first collector housing 41 comprises an outlet 45 for the airflow F. This first collector housing 41 thus makes it possible to recuperate the airflow F passing through the set of heat exchangers 23, and to orient this airflow F towards the outlet 45. The first collector housing 41 can be integral with the fairing 40 or else can be an added-on part secured on the downstream end 40b of said fairing 40.

As shown in FIG. 2, the cooling module 22 can also include a second header box 42 located upstream of the fairing 40 and the set of heat exchangers 23, opposite the first collector housing 41. This second collector housing 42 comprises an inlet 42a for the airflow F coming from outside the vehicle 10. The inlet 42a can in particular be positioned facing the cooling opening 18. This inlet 42a can also comprise the protective grille 20 (see FIG. 1). The second collector housing 42 can be integral with the fairing 40 or else be an attached component fastened to the upstream end 40a of said fairing 40.

The cooling module 22, more specifically the first collector housing 41, also comprises at least one tangential-flow fan, also known as a tangential-flow turbomachine 30, which is configured so as to generate the airflow F passing through the set of heat exchangers 23. The tangential-flow turbomachine 30 comprises a rotor or turbine 32 (or tangential blower-wheel). The turbine 32 has a substantially cylindrical shape. The turbine 32 advantageously comprises a plurality of stages of blades 320 (visible in FIG. 9). The turbine 32 is mounted such as to rotate around an axis of rotation, which for example is parallel to the direction Y, as shown in FIGS. 2 and 3. The diameter of the turbine 32 is for example between 35 mm and 200 mm so as to limit its size. The turbomachine 30 is thus compact.

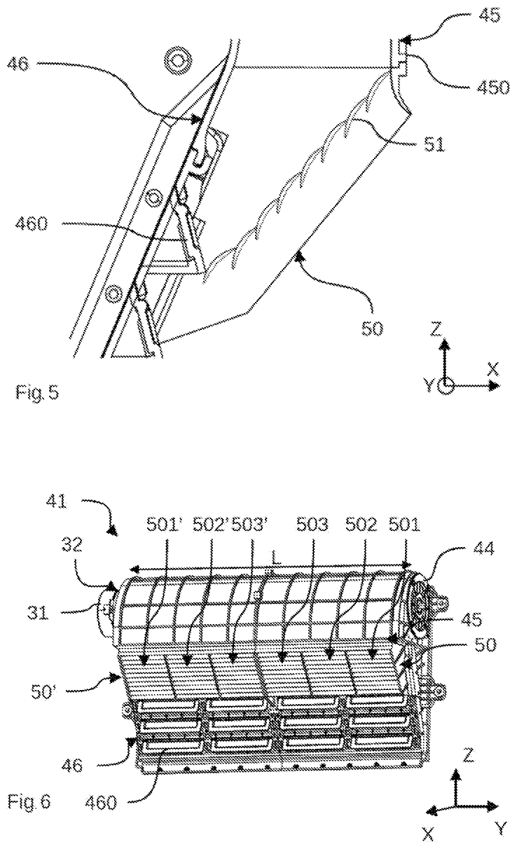

The tangential-flow turbomachine 30 can also comprise a motor 31 (visible in FIGS. 5 and 6) configured to rotate the turbine 32. The motor 31 is for example able to rotate the turbine 32 at a speed of between 200 rpm and 14,000 rpm. This notably makes it possible to limit the noise generated by the tangential-flow turbomachine 30.

The tangential-flow turbomachine 30 is positioned in the first collector housing 41. The tangential-flow turbomachine 30 is then configured to aspirate air in order to generate the airflow F passing through the set of heat exchangers 23. The tangential-flow turbomachine 30 comprises more specifically a volute 44, formed by the first collector housing 41, at the center of which the turbine 32 is arranged. The discharge of air from the volute 44 corresponds to the outlet 45 for the airflow F from the first collector housing 41.

In the example illustrated in FIGS. 2 to 3, the tangential-flow turbomachine 30 is in a high position, in particular in the upper third of the first collector housing 41, preferably in the upper quarter of the first collector housing 41. This notably makes it possible to protect the tangential-flow turbomachine 30 in the event of submersion, and/or to limit the space taken up by the cooling module 22 in its lower part. In this scenario, the outlet 45 for the airflow F is preferably oriented toward the lower part of the cooling module 22.

Here, upper and lower mean an orientation in the direction Z. An element referred to as upper will be closer to the roof of the vehicle 10 and an element referred to as lower will be closer to the ground.

In order to guide the air leaving the set of heat exchangers 23 to the outlet 45, the first collector housing 41 comprises, disposed facing the downstream end 40b of the fairing 40, a guide wall 46 for guiding the airflow F to the outlet 45.

The cooling module 22, and more specifically the first housing 41, also comprises at least one deflector grille 50 located at the outlet 45 of the volute 44. This deflector grille 50 extends from an outer edge 450 of the outlet 45 and lies on an inclined plane facing the guide wall 46. More precisely, the outer edge 450 of outlet 45 corresponds to the edge of the outer wall of the volute 44. The deflector grille 50 comprises a series of superimposed blades 51, each extending along a transverse axis Y perpendicular to the longitudinal direction X of the cooling module 22.

In particular, the at least one deflector grille 50 can be an attachment fixed on the one hand to the outer edge 450 of the outlet 45 and supported on the other hand on the separating wall 46 by means of support walls. The deflector grille 50 can be made of plastic.

As shown in FIG. 3, the at least one deflector grille 50 can extend in particular below the outlet 45 over a distance at least equal to the depth P of said outlet 45. In this way, the entire airflow F from outlet 45 passes through the at least one deflector grille 50. In addition, the inclination of the guide wall 46 and that of the at least one deflector grille 50 leave a gap to allow the flaps 460 of the guide wall 46 to open.

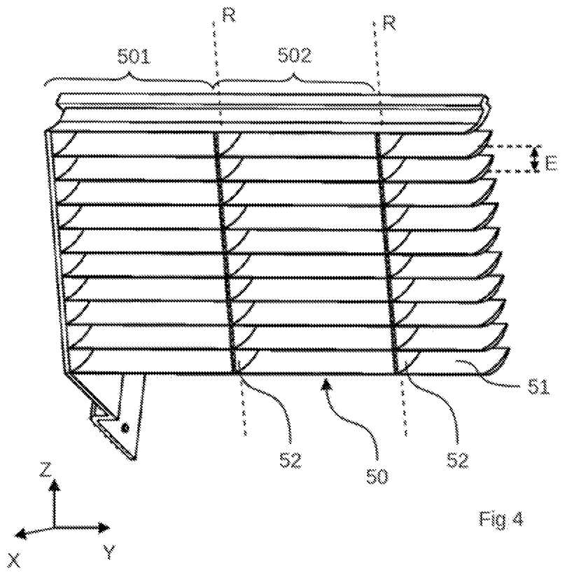

As shown in FIG. 4, a deflector grille 50 can comprise at least two compartments 501, 502, arranged side by side. Each compartment 501, 502, comprises a series of superimposed blades 51, and these compartments 501, 502, are separated by a separating wall 52. This separating wall 52 connects the superimposed blades 51 of each compartment 501, 502 to each other. More specifically, the separating walls 52 extend in a plane perpendicular to the blades 51 and enable the blades 51 to remain straight and not bend under their own weight. To ensure proper circulation of the airflow F, the distance E between the transverse axes Y of two adjacent blades 51 can be, in particular, between 5 and 20 mm. Preferably, this distance E can be 12 mm.

The blades 51 are rotatable about their transverse axis Y between an open position (shown in FIGS. 2 to 4) and a closed position (shown in FIG. 5).

In the open position, the airflow F can pass through the at least one deflector grille 50. In particular, the blades 51 are configured to deflect the airflow F away from the guide wall 46. In the open position, the deflecting wall 50 can thus deflect and orient the airflow F coming from the outlet 45 and direct it towards an area which, for example, is free of obstacles that could disrupt the circulation and discharge of the airflow F. The blades can in particular have a variable opening angle to guide the airflow F as required, in particular in order to bypass any obstacles within the motor vehicle 10 and thus enable proper discharge of the airflow F.

In the closed position, the blades 51 are inclined so that the airflow F cannot pass through the deflector grille 50. More precisely, and as illustrated in FIG. 5, in the closed position, the blades 51 are in contact with each other to form a stop surface for the airflow F. To ensure sealing in the closed position, the blades 51 can be fitted with seals (not shown) in the area where they come into contact with each other.

Still in the closed position, the blade 51 furthest away from the outer edge 450 can, in particular, be both in contact with the adjacent blade 51 by a first of its edge and in contact with the separating wall 46 at a second of its edge, opposite the first. This makes it possible in particular to completely block the airflow F and thus close the gap allowing the flaps 460 of the guide wall 46 to open.

In order to set the blades 51 in motion, the deflector grille 50 can comprise an actuator and a device for transmitting the rotation (not shown) from the actuator to the blades 51. This transmission device can, for example, comprise a lever and a connecting rod to rotate the blades 51 simultaneously. The actuator can be an electric motor, for example, or a manual mechanism for orienting the blades 51 when the cooling module 22 is installed.

The presence of this deflector grille 50, and in particular the fact that it has a closed position, enables the airflow F to be blocked. This means that the vehicle 10, or more precisely the second collector housing 42 of the cooling module 22, does not need to have a front-end closing device. The airflow F is thus not blocked upstream of the cooling module 22, but downstream of it. The cooling module 22 is therefore more compact, as it does not require a front-end closing device, and can also be lighter.

In particular, the blades 51 of each compartment 501, 502 can be independently rotatable from one compartment 501, 502 to another. Each compartment 501, 502 then has a dedicated actuator and transmission device. This then enables the airflow F to be precisely oriented in order to avoid any obstacles within the motor vehicle 10.

The separator walls 52 can also be movable to precisely orient the airflow F. More specifically, the separator walls 52 can be moved around an axis of rotation R perpendicular to the transverse axis Y of the blades 51. The airflow F is then oriented laterally by these separator walls 52, while the airflow F is oriented vertically by the blades 52.

As shown in FIG. 6, the at least one deflector wall 50, 50′ can cover the entire width L of the outlet 45 of the cooling module 22. In the example shown in FIG. 6, the first collector housing 41 has two deflector grilles 50 and 50′ arranged at the outlet 45 of the volute 44. These two deflector grilles 50, 50′ are arranged side by side so as to cover the entire width L of the outlet 45.

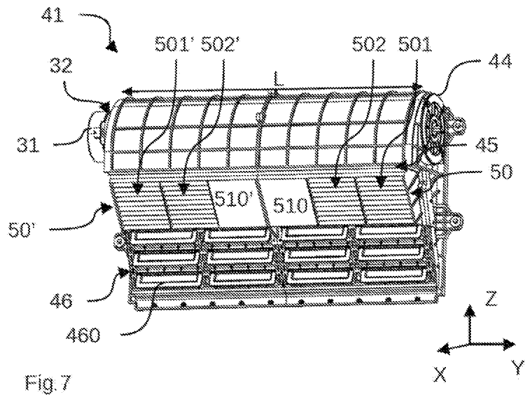

According to a variant shown in FIG. 7, the outlet 45 of the cooling module 22 can comprise at least one area without at least one deflector grille 50, 50′. In the example shown in FIG. 7, the first collector housing 41 has two deflector grilles 50 and 50′ arranged at the outlet 45 of the volute 44. These two deflector grilles 50, 50′ are arranged next to each other, but each has an area without blades 51. The area of the outlet 45 without at least one deflector grille 50 can comprise, in particular, a blocking wall 510, 510′ extending in the same plane as the at least one deflector grille 50, 50′. This area without a deflector grille 50, 50′ enables compartmentalized management of the airflow F, with the latter being deflected at the at least one deflector grille 50, 50′ and discharged freely at the area without a deflector grille 50, 50′, or blocking the airflow if this area comprises a blocking wall 510, 510′.

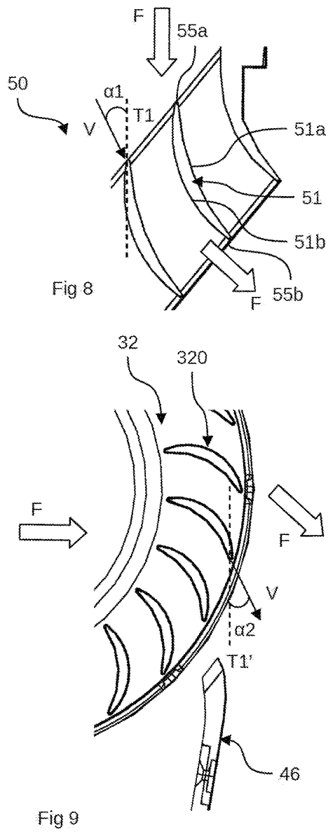

As shown in FIG. 8, the blades 51 of the at least one deflector grille 50 can in particular have a curved cross-section with a first concave wall 51a facing the outlet 45 and a second convex wall 51b facing away from the outlet 45. More precisely, the blades 51 can comprise a leading edge 55a through which the airflow F is intended to arrive against said blade 51 and a trailing edge 55b through which the airflow F is intended to be ejected from said blade 51. The thickness of the cross-section of the blade 51 at said leading edge 55a and trailing edge 55b can be less than the central thickness of the cross-section of blade 51. This teardrop shape of the cross-section of the blade 51 ensures good flow and deflection of the airflow F, while limiting pressure losses.

As shown in FIGS. 8 and 9, there is a particular relationship between the shape of the blades 320 of the turbine 32 and the blades 51 of the deflecting grille 50. More particularly, the angle α1 between the tangent T1 to the leading edge 55a of the blades 51 of the at least one deflector grille 50 and the velocity vector V of the airflow F is equal to the angle α2 between the tangent T1′ to the trailing edge of the blades 51 of the turbine 32 and the velocity vector V of the airflow F leaving said turbine 32. The velocity vector V corresponds here to the velocity vector of the airflow F as it passes through the at least one deflector grille 50 and the turbine 32 respectively. This relationship allows, in particular, the airflow F to circulate more efficiently, notably by limiting pressure losses.

As can be seen, the addition of at least one deflector grille 50 makes it possible to orient the airflow F at the outlet 45 as required for improved circulation of said airflow F. This eliminates any obstacles present in the compartment designed to house the cooling module 22. In addition, the fact that the blades 51 of the at least one deflector grille 50 are movable into a closed position eliminates the need for a front-end closing device to block the airflow F. This means that the cooling module 22 can remain compact and light enough to fit inside the motor vehicle.

What is claimed is:

1. A cooling module for an electric or hybrid motor vehicle, intended to have an airflow passing there through and comprising:
a fairing forming an internal channel through which the airflow passes between an upstream end and a downstream end opposite each other, said fairing including at least one heat exchanger,
a first collector housing arranged downstream of the fairing in a longitudinal direction of the cooling module from the front to the rear of said cooling module, said first collector housing including a guide wall facing the at least one heat exchanger downstream of the fairing, said guide wall being intended to guide the airflow towards a tangential turbomachine configured so as to generate said airflow, said tangential turbomachine including a volute including an outlet for the airflow,
wherein the cooling module further comprises at least one deflector grille arranged at the outlet of the volute, said at least one deflector grille extending an outer edge of the outlet and lying on an inclined plane oriented towards the guide wall,
said at least one deflector grille including a series of superimposed blades each extending along a transverse axis-axis perpendicular to the longitudinal direction of the cooling module, said superimposed blades being rotatable about their transverse axis between a closed position and an open position.

2. The cooling module as claimed in claim 1, wherein, in the closed position, the superimposed blades are in contact with each other to form a stop surface for the airflow.

3. The cooling module as claimed in claim 1, wherein a blade of the superimposed blades located furthest away from the outer edge is, in the closed position, both in contact with an adjacent blade of the superimposed blades by a first of its edges and in contact with the separating wall by a second of its edges, opposite the first.

4. The cooling module as claimed in claim 1, wherein the at least one deflector grille includes at least two compartments, arranged side by side, each compartment including a sub-series of superimposed, the compartments being separated by a separating wall connecting the sub-series of superimposed blades of each compartment to each other.

5. The cooling module as claimed in claim 4, wherein the superimposed blades of each compartment are independently rotatable from one compartment to another.

6. The cooling module as claimed in one claim 4, wherein the separator walls is movable about an axis of rotation perpendicular to the transverse axis of the superimposed blades.

7. The cooling module as claimed in claim 1, wherein the entire width of the outlet of the cooling module is covered by the at least one deflector grille.

8. The cooling module as claimed in claim 1, wherein the superimposed blades of the at least one deflector grille have a curved cross-section with a first concave wall facing the outlet and a second convex wall facing away from the outlet.

9. The cooling module as claimed in claim 1, wherein the superimposed blades include a leading edge through which the airflow is intended to impinge against said blade, a trailing edge through which the airflow is intended to be ejected by said blade, the thickness of the cross-section of the blade at said leading and trailing edges being less than the central thickness of the blade cross-section.

10. The cooling module as claimed in claim 9, wherein, in the open position, the angle between the tangent to the leading edge of the superimposed blades of the at least one deflector grille and the velocity vector of the airflow is equal to the angle between the tangent to the trailing edge of the superimposed blades of the turbine and the velocity vector of the airflow leaving said turbine.
